(19) United States
(12) Patent Application Publication
(10) Pub. No.: US 2017/0286082 A1
(43) Pub. Date: Oct. 5, 2017

(54) DE-DUPLICATION DURING FLASHING OF MOBILE DEVICES

(71) Applicant: MICROSOFT TECHNOLOGY LICENSING, LLC, Redmond, WA (US)

(72) Inventors: Robert Yu Zhu, Bellevue, WA (US); Ying N. Chin, Bellevue, WA (US); Dejun Zhang, Redmond, WA (US); Bin Wang, Bellevue, WA (US); Satyendra Bahadur, Yarrow Point, WA (US); Xuejun Chen, Redmond, WA (US); Haifeng Zheng, Redmond, WA (US); Pengxiang Zhao, Bellevue, WA (US)

(21) Appl. No.: 15/087,928

(22) Filed: Mar. 31, 2016

(51) Int. Cl. G06F 9/445

(52) U.S. Cl. CPC G06F 8/61

(57) ABSTRACT

A workbench identifies a plurality of mobile devices that are ready to be flashed and which are tethered to the workbench. The workbench also accesses one or more common payload packets to be flashed to each of the mobile devices from volatile memory of the workbench computing system, as well as one or more uncommon packets that are to be selectively flashed to only a subset of the plurality of mobile devices during the flashing session. Upon accessing and/or formatting the packets, the workbench computing system transmits the common payload packet(s) to the plurality of ready to be flashed mobile devices concurrently, while refraining from making or simultaneously storing a separate copy of the one or more common payload packets in the volatile storage for each of the plurality of mobile devices during the flashing session.

Mobile phones and other mobile devices are configured with software, such as Operating System (OS) software and device specific software that is installed within a hard drive or other non-volatile storage location of the mobile devices, such as an eMMC (embedded multimedia card), during a process called ‘flashing.’

Device flashing can be performed by an OEM (Original Equipment Manufacturer) prior to distribution, by an intermediary vendor subsequent to distribution, and/or by end users.

During flashing, a mobile device is physically tethered to a computing system, referred to herein as a workbench or workbench computing system, which contains the software to be installed on the mobile device. A USB cable is typically used to physically tether the mobile device to the workbench during flashing. It is also possible to use a USB hub to physically tether multiple devices to a single workbench for concurrent flashing of multiple devices during a single flashing session.

The software to be installed on the device(s) is first formatted into an appropriate image file and is transmitted through the physical tether to the device. There are various file formats that can be used for transmitting software images during flashing, such as a .WIM (Windows Image) format, a .VHD/.VHDX (Virtual Hard Disk) format, a .FFU (Full Flash Update) format, and other formats.

Each of the image files to be flashed to the mobile devices is initially stored or cached at the workbench computing system prior to being transmitted to the mobile devices during the flashing session. When multiple devices of correspondingly different types and/or configurations are flashed concurrently from a single workbench, that workbench stores a separate image for each of the different device types/configurations. This can result in an undesirable storage burden upon the workbench when several different types of devices are concurrently flashed.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

The disclosed embodiments include systems, methods and storage devices configured for facilitating efficient flashing of mobile devices during flashing sessions in which a plurality of mobile devices are concurrently flashed from a single workbench.

Some disclosed embodiments include de-duplicating the data that is flashed to the plurality of mobile devices in such a way as to facilitate a reduction storage requirements of the data at the workbench and a reduction in the processing requirements for formulating the image files that are ultimately transmitted to the mobile devices during the flashing session(s).

In some instances, a workbench computing system is used to concurrently flash a plurality of different devices that are tethered to the workbench computing system. The workbench computing system initially identifies the plurality of mobile devices that are ready to be flashed and which are tethered to the workbench computing system. Then, the workbench computing system accesses one or more common payload packets to be flashed to each of the mobile devices from volatile memory of the workbench computing system, as well as one or more uncommon packets that are to be selectively flashed to only a subset of the plurality of mobile devices during the flashing session. Upon accessing and/or formatting the packets, the workbench computing system transmits the common payload packet(s) to the plurality of ready to be flashed mobile devices concurrently, while refraining from making or simultaneously storing a separate copy of the one or more common payload packets in the volatile storage for each of the plurality of mobile devices during the flashing session. The mobile devices are then untethered from the workbench computing system after the payload packet(s) have been uploaded to the mobile devices.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing environment that includes a workbench computing system that is connected to at least one mobile device that is being flashed by the workbench computing system;

FIG. 2 illustrates a computing environment that includes a mobile device and a plurality of files that are first converted into a VHD file and subsequently converted into a FFU file for flashing to a mobile device;

FIG. 3 illustrates one embodiment of a FFU file different portions of the FFU file;

FIG. 4 illustrates a computing environment that includes mobile device and a plurality of files that are configured for flashing to the mobile device as individual file or file segments;

FIG. 5 illustrates a computing environment that includes a workbench computing system and a mobile device having RAM and EMMC, wherein a file image segment is transferred from the workbench computing system to the mobile device during a flashing process;

FIG. 6 illustrates a computing environment that includes a workbench computing system and a mobile device having RAM and EMMC, wherein a file image segment is transferred from the workbench computing system to the mobile device during a flashing process and in which a notice or acknowledgement is generated to acknowledge receipt of the image segment by the mobile device;

FIG. 7 illustrates a flowchart with acts corresponding to methods for burst flashing one or more mobile device(s), from the perspective of a flashing workbench computing system;

FIG. 8 illustrates a flowchart with acts corresponding to methods for burst flashing a mobile device, from the perspective of a user and workbench.

### DETAILED DESCRIPTION

The disclosed embodiments include systems, methods and storage devices configured for facilitating efficient flashing of mobile devices during flashing sessions in which a plurality of mobile devices are concurrently flashed from a single workbench.

Some disclosed embodiments include de-duplicating the data that is flashed to a plurality of mobile devices in such a way as to facilitate a reduction storage requirements of the data at the workbench and a reduction in the processing requirements for formulating the image files that are ultimately transmitted to the mobile devices during the flashing session(s). For instance, it is possible to flash an OS image file and other common image files to a plurality of different devices (which may include different types and configurations of devices), without having to store a separate copy of the common image files at the workbench computing system for each of the different devices that are concurrently flashed. This represents a significant technical benefit in the industry of mobile device manufacture and maintenance by at least reducing the amount of storage and processing requirements needed by a workbench when flashing a plurality of multiple mobile devices.

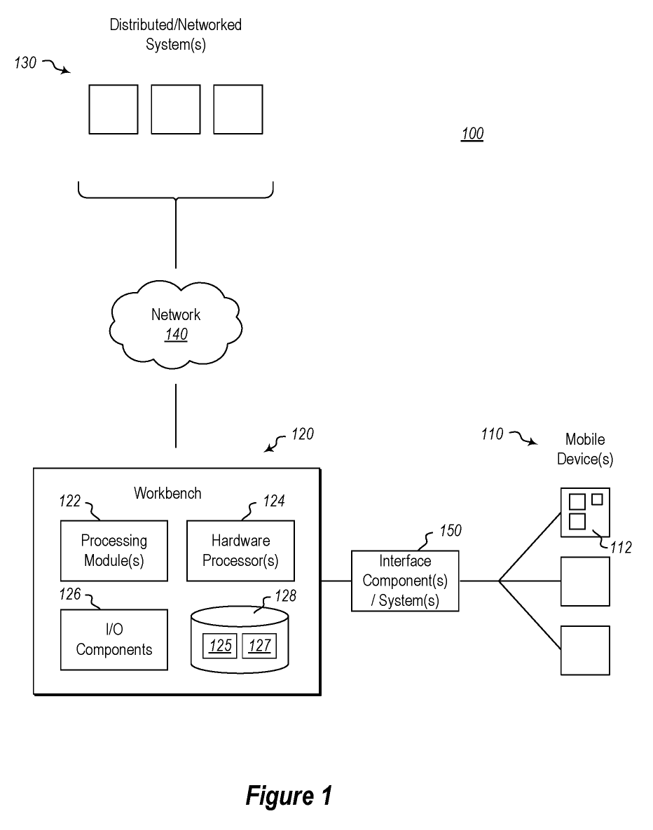

FIG. 1 illustrates a computing environment in which one or more mobile device(s) 110 are burst flashed by a workbench computing system 120. The mobile device(s) 110 include one or more mobile phones, tablets, phablets, watches, wearable computing devices and/or any other portable device having an eMMC and/or other non-volatile memory capable of being flashed/written to.

This workbench computing system can be an isolated and stand-alone computing system or an integrated computing system that is connected to one or more distributed systems 130 through a corresponding network 140. These distributed systems 130 can be remotely located from the workbench computing system 120 or locally located relative to the workbench computing system 120.

The bursting workbench computing system 120 is physically tethered to the plurality of mobile devices 110 during the flashing session with one or more interface component(s)/system(s), such as a USB cable or another similar interface cable between the workbench 120 and the mobile devices 110. In some instances, one or more an intermediary USB hubs and/or other computing components are connectively positioned between the workbench 120 and the mobile device(s) with the USB cable.

The workbench computing system 120 includes various components for facilitating the flashing that is disclosed herein. For instance, the computing system 120 includes one or more processing module(s) 122 having stored computer-executable instructions that are executable by one or more hardware processor(s) 124 for implementing the methods and other functionality disclosed herein. The workbench computing system 120 also includes I/O components such as displays, keyboards, and UI interfaces that are configured to receive input and to generate output.

The workbench computing system 128 also includes one or more storage device 128 that includes one or more volatile and/or non-volatile memories. The storage device 128 stores processing module(s), interfaces and other stored data that is used for performing the flashing that is disclosed herein. This stored data also includes the actual files/images that are transmitted to the mobile devices during the flashing (including common payload files/packets 125 and unique payload files/packets 127), as well as interfaces that are operable to monitor progress of the flashing and that otherwise facilitate interfacing of the workbench 120 with the mobile devices 110 and other systems disclosed herein.

Each of the mobile devices 110 being flashed is also configured with corresponding I/O components, processing modules, hardware processors, and storage devices for facilitating the flashing that is disclosed herein. For instance, the mobile devices 110 include communication components for communicating with the workbench 120, processing components for reading and writing data (including the flashed images), volatile memory (e.g., RAM), non-volatile memory (e.g., eMMC) and so forth. While there may be any number of components included within the mobile devices 110, these components are collectively illustrated as the three boxes of mobile device 112.

In some embodiments, the mobile devices 110 are pre-configured with a suitable Basic Input/Output System (BIOS) or Unified Extensible Firmware Interface (UEFI) that is capable of facilitating USB discovery and data transfer and writing of received data to the non-volatile storage of the mobile device. In this regard, the mobile devices 110 are referred to, herein, as ready to be flashed mobile devices 110. When the mobile devices are not preconfigured with suitable BIOS or UEFI, then the disclosed methods further include installing the BIOS or UEFI onto the mobile device prior to the flashing session or as part of the flashing session, thereby making the mobile devices 110 ready to be flashed with the common and unique payload packets described herein.

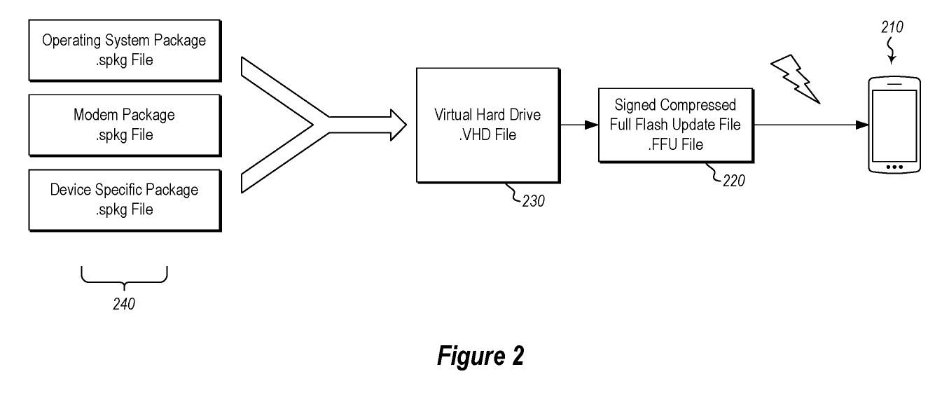

During flashing, one or more files are formatted into an appropriate image format and transmitted through the USB tether and/or other intermediary components to the mobile device(s) 110. Transfer of an image is further illustrated with respect to FIG. 2.

As shown in FIG. 2, a mobile device 210 is flashed with a signed and compressed Full Flash Update File (.FFU file) 220. The FFU file 220 is a specialized type of image that is used for transmitting installation files to a mobile device. The signing and/or encrypting of the FFU file is performed with the OEM certificate and/or another certificate that is usable to prevent malicious software from being installed on the mobile device 210. For instance, the mobile device is configured to verify the certificate of a received image file matches a known certificate/key prior to writing the received data to non-volatile memory. This is particularly important when the image file includes critical system software. In some embodiments, the FFU file includes OS software and device specific software, such as modem communication software.

The FFU file is processed and stored at the workbench computing system prior to being transferred to the mobile device during the flashing session. When a plurality of mobile devices are concurrently flashed, the OS software and other device specific software is converted into a suitable FFU file for each of the mobile devices being flashed. Traditional systems include the common files (such as OS software that will be installed onto each of the mobile devices) into each of the different FFU files that are created, stored and/or otherwise processed at the workbench. This can create an undesired storage and processing burden on the workbench, particularly when duplicate and redundant processing must be performed for the same OS or other common files within each of the different FFU image files. This processing can include, for example, redundantly compressing and segmenting the same OS software within a plurality of different FFU files that are configured for different mobile devices that are concurrently flashed.

By way of further example, each of the FFU files can be created/processed as a digitally signed and compressed version of a Virtual Hard Drive file (.VHD file) which is composed of one or more separate .spkg files 240, such as the illustrated operating system package file, the modem package file, or another device specific package file that is executable by the hardware/processor(s) of the mobile device 210. These .spkg files can be common files, which are suitable for and transmitted to all of plurality of the mobile devices that are being concurrently flashed (e.g., OS and modem package files). One or more of the .spkg files can also be unique files which are not suitable for nor transmitted to all of the mobile devices being concurrently flashed (e.g., device specific package files).

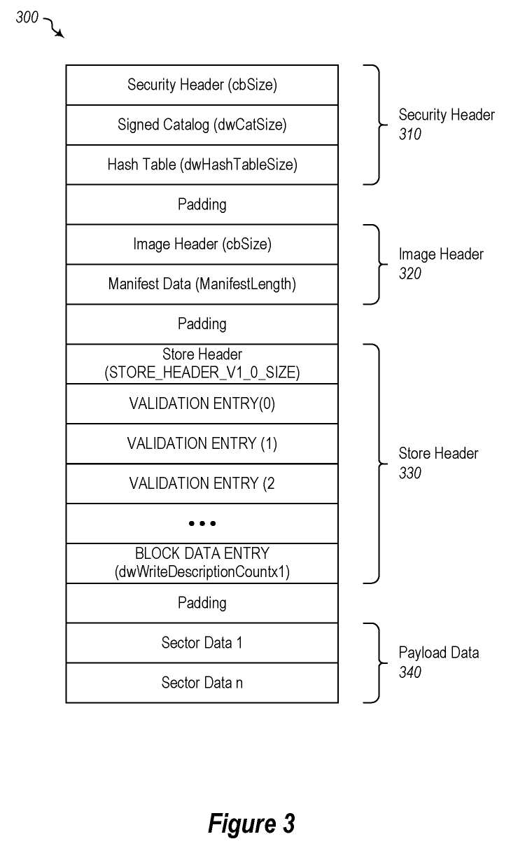

FIG. 3 illustrates one example of a FFU file 300, which includes a security header portion 310, an image header portion 320, a store header portion 330 and a payload data portion 340. The security header 310 is used to validate and authenticate credentials of the image data. The image header 320 is used to identify the type of image data and manifest tracking information. The store header 330 is used to validate specific entries of the data to be installed and the payload data 340 comprises the data that is being installed.

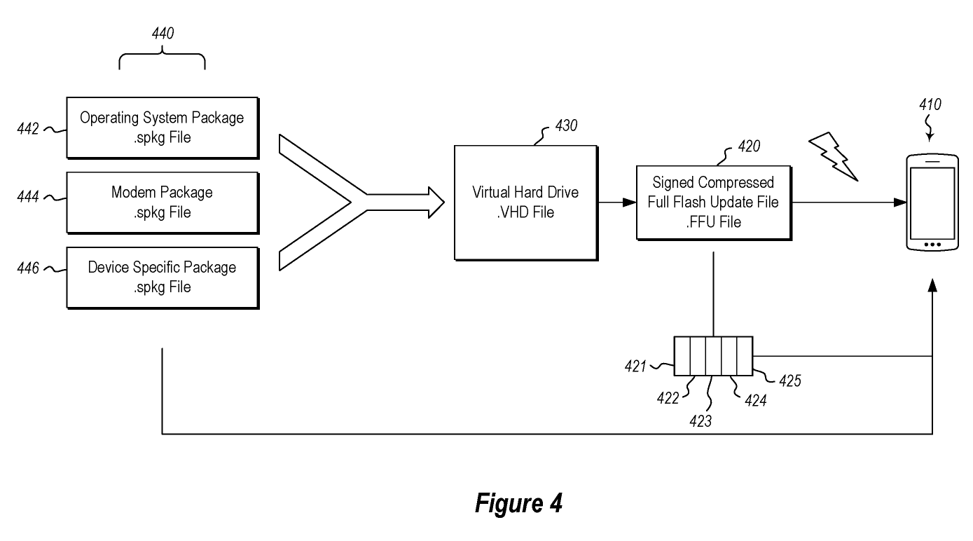

FIG. 4 illustrates how, in some embodiments, the image file is segmented during the flashing session prior to being transmitted to the mobile device 410. For instance, FFU file 420 is illustrated as being segmented into five (5) individual segments 421, 422, 423, 423 and 425. However, it will be appreciated that the file 420 can also be segmented into other quantities of two or more segments. The image segments are transmitted in a predetermined sequence/series to the mobile device 410 from the workbench computing system and/or USB hub. According to some instances, each of these segments is individually signed by the OEM certificate prior to the transfer. The size and quantity of the segments is also identified and stored in a table or other data structure. This information is used, in some instances, for tracking and confirming successful transmission of the segments to the volatile storage of the mobile device, as described in more detail below.

As suggested above, the operating system .spkg file 442, the modem .spkg file 444 and/or other device specific .spkg file(s) 446 can be converted into a single consolidated .VHD file 430 prior to being digitally signed and converted into a corresponding FFU file 420 that is later segmented. Although, in some embodiments, the files to be flashed are not converted into a .VHD or FFU file prior to transmission.

In some of the disclosed embodiments, as described throughout, the specific files 440 are separately or individually transmitted to the mobile device(s), without being consolidated with one or more other files that are also transmitted during a single flashing session. For instance, a common file is not combined with or otherwise consolidated with the unique file(s) into a single .VHD or FFU file during the flashing, such that the common file and unique file(s) are transmitted separately (e.g., as separate .VHD or FFU files or other file images) to the corresponding mobile devices.

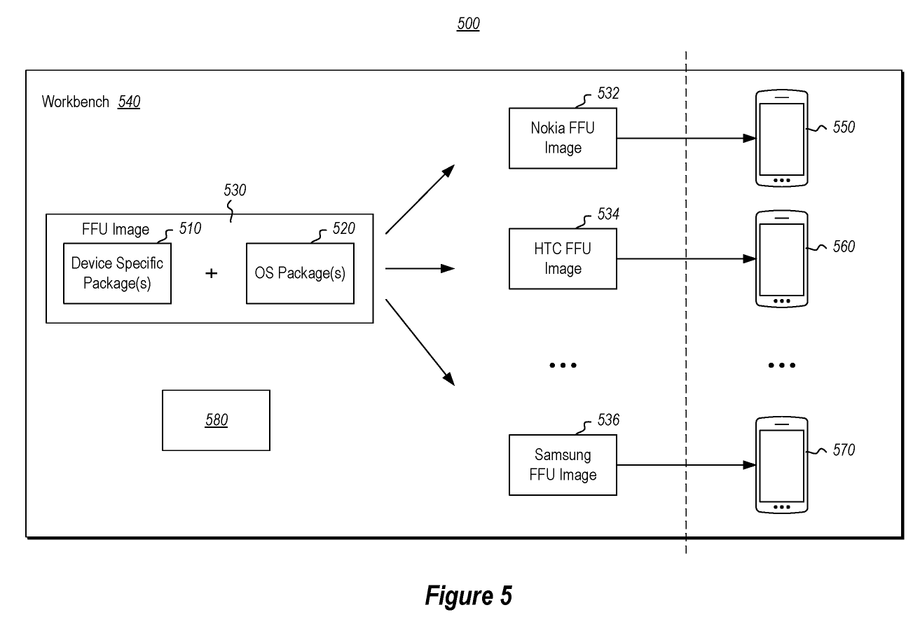

The foregoing clarification will further be illustrated by FIG. 5. For instance, traditional systems will combine/consolidate the unique device specific package(s) 510 and the common OS package(s) 520 into a single image 530 to be flashed. As described above, this image 530 is stored and processed at the workbench 540 prior to being transmitted to the corresponding mobile devices, which in this case includes a Nokia device 550, an HTC device 560 and a Samsun device 570. This represents unnecessary duplication of storage and processing, including redundant formatting and compressing of the OS and other common package(s) sent to all of the devices 550, 560 and 570. More specifically, the FFU image 530 is actually stored, in this embodiment, as three separate images (532, 534 and 536), that are each processed and stored at the workbench 550. For instance, the Nokia FFU image 532 will include the OS and other common package(s) 520 as well as the Nokia device specific package(s). Likewise, the HTC FFU image 534 includes the OS and other common package(s) 520 along with corresponding HTC device specific package(s). The Samsung FFU image 536 also includes the OS and other common package(s) 520 along with corresponding Samsung device specific package(s). Each of these files is independently processed and transmitted, even when transmitted during a common/concurrent session. This storage and processing of the OS and other common package(s) represents an unnecessary burden on the workbench and an inefficient use of resources.

The newly disclosed embodiments for flashing the devices includes de-duplicating the common files/packages from the unique/device-specific files/packages. For instance, rather than duplicate storage of the OS and other common package(s), according to the current disclosure, the Nokia Image 532, the HTC Image 534 and the Samsung Image 536 are created, processed and stored without the OS package(s), which will be stored and processed separately as an independent set of one or more image file(s) 580 by the workbench 540.

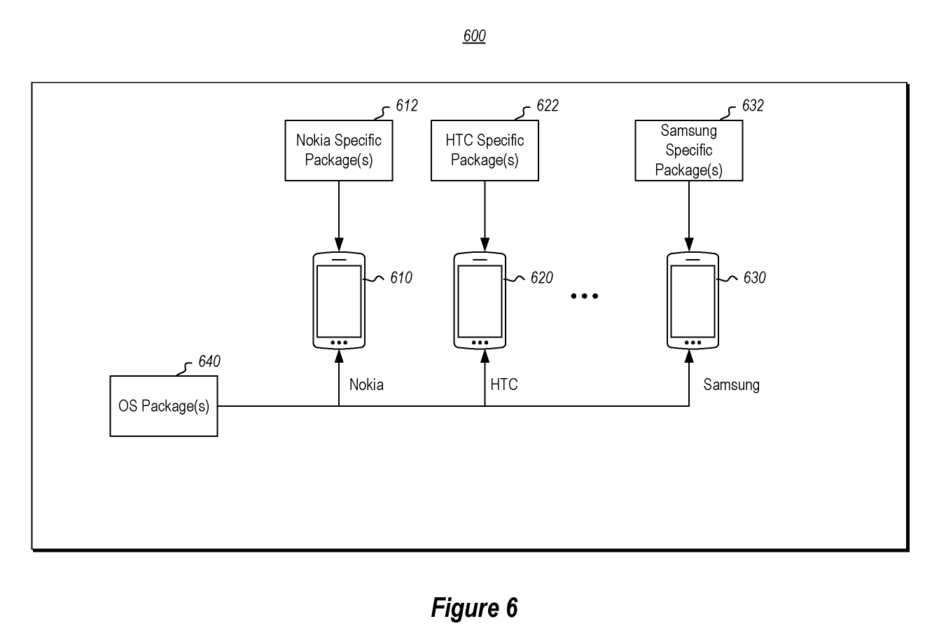

FIG. 6 illustrates the de-duplication flashing process a little more clearly. As shown, the Nokia device 610 receives the Nokia specific package(s) 612 (which will be formatted as one or more segments of an FFU image, a .VHD image or another image) separately from the OS and other common package(s) 640 (that are also formatted as one or more segments of a different FFU, .VHD or other image). Likewise, the HTC device 620 receives the HTC specific package(s) 622 in an appropriate image separately from the image of the OS and other common package(s) 640 and the Samsung device 630 receives the Samsung specific package(s) 632 in an appropriate image separately from the image of the OS and other common package(s) 640. In other words, the OS and other common package(s) are de-duplicated from the unique device specific packages.

It will be appreciated that the OS software is not always considered a common package that is de-duplicated from the unique/device-specific packages. For instance, when a unique OS is required for one or more devices (but not all of the devices), that OS software is considered device specific and will also be separated from the common packages that are de-duplicated from the unique packages. The unique and device specific software can sometimes correspond to multiple devices in the set of devices being concurrently flashed. However, if a software/package is not required for all of the devices that are concurrently being flashed, then that software/package will not be de-duplicated. For instance, if the Nokia device 610 and the HTC device 620 require a particular modem package, but the Samsung device 630 does not, then the modem package will be redundantly formatted with and stored within the separately Nokia specific package(s) 612 and the HTC specific package(s) 614.

In alternative embodiments, anytime a software/package is required by multiple devices, it will be de-duplicated/stored and processed separately from the software/packages that are entirely unique to only a single device. In yet other embodiments, a threshold number of devices must be common targets for software/packages being flashed prior to de-duplicating/separating the software/packages from the unique software/packages, such as threshold of 2, 3, 4 or more common target devices.

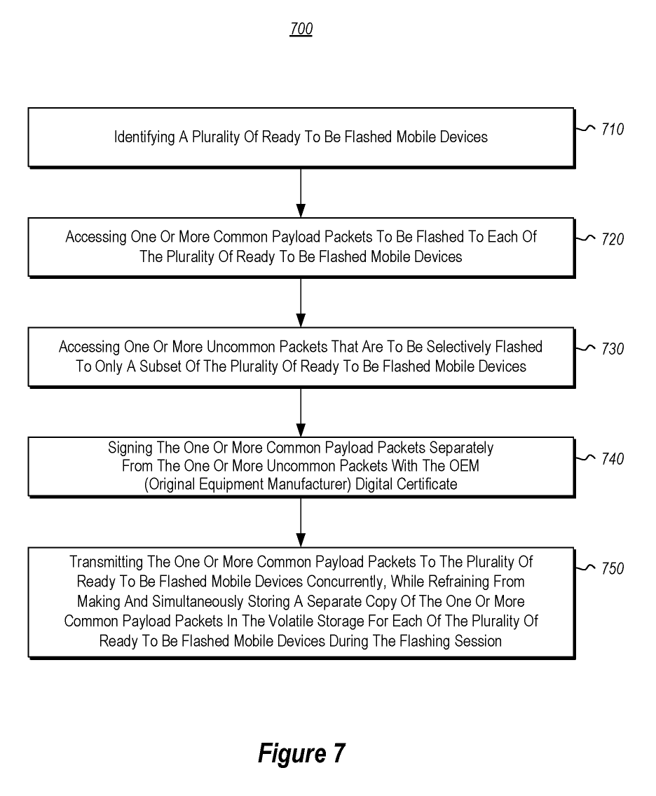

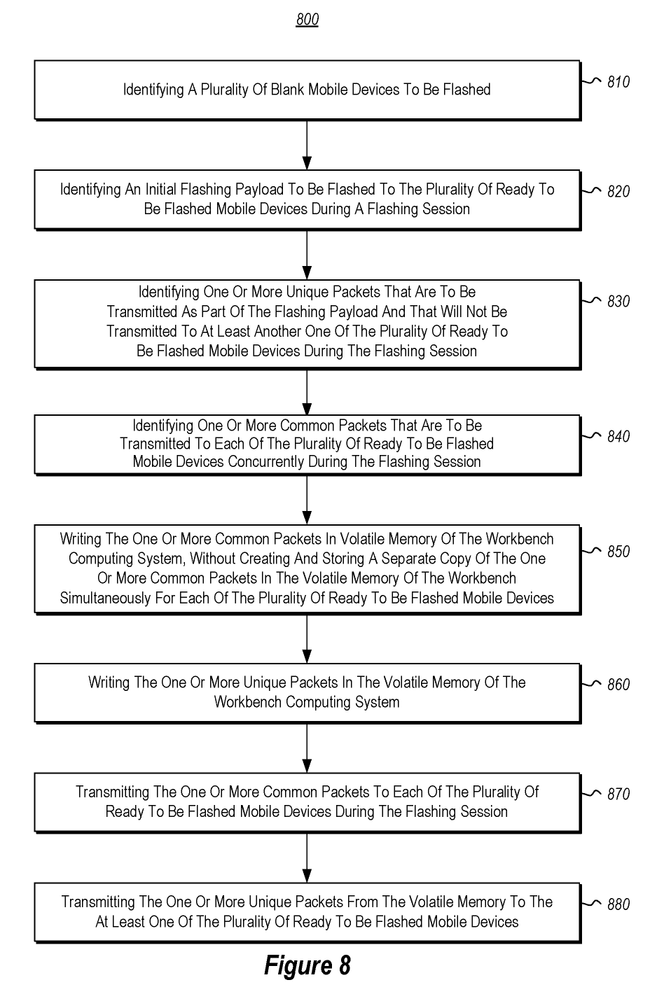

Attention will now be directed to FIGS. 7-8, which illustrate flowcharts 700 and 800 that represent methods for efficient flashing that includes de-duplicating common payload packets from unique payload packets when flashing multiple devices during a concurrent session.

Each of the flowcharts 700 and 800 includes a plurality of acts that are performed during implementation of the corresponding method(s). These acts are illustrated and sometimes described as being performed in a particular order. It will be appreciated, however, that no particular ordering is required for performing the acts of the disclosed methods or any of the other related methods covered by the scope of this disclosure, unless specifically stated, or unless specifically required because an act is dependent on another act being completed prior to the act being performed.

As illustrated in FIG. 7, some embodiments for flashing a plurality of devices includes a workbench computing system identifying the plurality of ready to be flashed mobile devices (710), wherein the plurality of ready to be flashed mobile devices being tethered to the workbench computing system during a single flashing session, and wherein the plurality of ready to be flashed mobile devices are ultimately untethered from the workbench computing system upon completion of the flashing session.

The workbench computing system also accesses one or more common payload packets (720) to be flashed to each of the plurality of ready to be flashed mobile devices from volatile memory of the workbench computing system during the flashing session as well as one or more uncommon packets (730) that are to be selectively flashed to only a subset of the plurality of ready to be flashed mobile devices during the flashing session. This process of accessing the payload packets (720 and 730) includes, in some embodiments, the creation of the payload packets. It also includes, in some embodiments, the separation of the common packets from the uncommon packets. The separation is based on detected properties of the devices to be flashed (e.g., what type of device it is and software still needs to be installed). This process may include comparing a manifest of installed software that is received from at workbench from the mobile device(s), automatically upon tethering to the mobile device(s), and/or responsively upon querying the mobile device(s) for the information that is used to determine device type and attributes (including software attributes).

The workbench independently de-duplicates the packages based on its own analysis in some instances. In other instances, the de-duplication is based on user input that is entered at the workbench by a user that specifies which of the common files/packages are to be de-duplicated.

In some embodiments, the common package(s) will be accessed and stored separately at the workbench from the unique/device specific package(s) within the volatile memory of the workbench. In other embodiments, the package(s) are stored in non-volatile storage of the workbench. In yet other embodiments, either the common package(s) or the unique package(s) are stored in non-volatile storage and the alternate unique or common package(s) are stored in volatile storage.

Once the payload packets are accessed and stored at the workbench (in the appropriate de-duplicated configuration), the workbench computing system transmits (750) the one or more common payload packets to the plurality of ready to be flashed mobile devices concurrently during the flashing session. This transmitting may include formatting and segmenting the packages, as previously described. Notably, however, the transmission occurs while refraining from making and simultaneously storing a separate copy of the one or more common payload packets in the volatile storage for each of the plurality of ready to be flashed mobile devices during the flashing session. This will, therefore, significantly reduce storage burdens placed on the RAM of the workbench during the flashing session.

Since the workbench computing system also refraining processing the packets into separate FFU (Flash File Uploader) files that includes the one or more common payload packets for each of the plurality mobile devices, the workbench computing system is also able to experience a reduction in the processing overhead that would otherwise be required to redundantly format/segment the same common packets within each of the FFU images. Instead, the common packet(s) can be simply formatted a single time into a FFU image for multiple different devices. The segmenting may also be simplified to require segmenting of the common packet(s) only a single time for the multiple devices, rather than once for each device specific FFU image that is processed.

In some embodiments the transmitting also includes or is supplemented by a digital signing of the packets 740. In such instances, the common packets are digitally signed with the OEM certificate or another certificate separately from the device specific packet(s).

The method reflected by the flowchart 800 of FIG. 8 is similar to the method described above. However, some additional acts are also implemented. In this embodiment, the workbench identifies a plurality of blank or other ready to be flashed mobile devices (810) to be flashed. A device may be considered blank if it excludes an OS. In other embodiments, a blank device is a device that only has basic I/O software installed, without any other software installed. In yet other embodiments, the device is a post-flashed device that is being re-flashed and that includes an OS and other software.

Irrespective of the device state and device type, the workbench identifies a plurality of ready to be flashed mobile devices that are being concurrently tethered to the workbench computing system. The identification can be automatic (e.g., automatically based on device detection software running on the workbench when the mobile devices are tethered to the workbench) and/or or manual (e.g., based on user input entered at the workbench).

The workbench also identifies an initial flashing payload to be flashed to the plurality of ready to be flashed mobile devices during a flashing session (820). This identification can be performed automatically and/or manually, as previously described, by identifying device type and/or software configurations/requirements for the different devices.

The workbench then identifies one or more unique packets that are to be transmitted to at least one of the plurality of ready to be flashed mobile devices as part of the flashing payload and that will not be transmitted to at least another one of the plurality of ready to be flashed mobile devices during the flashing session (830), as well as one or more common packets from the initial flashing payload that will be transmitted to each of the plurality of ready to be flashed mobile devices concurrently during the flashing session (840). Again, this may be done automatically and/or in response to user input received at the workbench.

In some embodiments, information used by the workbench for identifying/distinguishing between the one or more common packets and the one or more unique packets includes information obtained at the workbench computing system prior to tethering of the plurality of ready to be flashed mobile devices to the workbench computing system. In some alternative and/or augmented embodiments, information used for identifying/distinguishing is obtained from the plurality of mobile devices upon tethering the plurality of ready to be flashed mobile devices to the workbench computing system and which was installed on the plurality of ready to be flashed mobile devices prior to the flashing session and prior to an operating system having been installed on the mobile devices.

Timing for identifying of the one or more common packets and the one or more unique packets can occur prior to and subsequent to the tethering. For instance, the identifying information can be obtained at the workbench computing system prior to tethering of the plurality of ready to be flashed mobile devices to the workbench computing system (based on user input or third party information). Additionally, or alternatively, identifying information can be obtained from the device(s), the user and/or third parties after the tethering. The timing can also occur in stages and/or subsequent to the transmitting of at least some of the packets (e.g., subsequent to transmission of one or more common packet(s)).

In some embodiments, multiple devices that are manufactured from a same OEM (original equipment manufacturer), but are still configured to receive different combinations of common and/or unique packets, based on the identifying information. In one embodiment, at least one unique packet is selectively flashed to one mobile device of a particular OEM, without being flashed to at least one other device from the same OEM, during the flashing session.

The flowchart 800 of FIG. 8 also illustrates how the workbench writes the one or more common packets in volatile memory of the workbench computing system, without creating and storing a separate copy of the one or more common packets in the volatile memory of the workbench simultaneously for each of the plurality of ready to be flashed mobile devices that are tethered to the workbench (850).

The one or more unique packets are also written to the volatile memory of the workbench computing system (860), separate from the de-duplicated common packet(s).

Finally, the one or more common packets are concurrently transmitted to each of the plurality of ready to be flashed mobile devices during the flashing session (870). The one or more unique packets are also transmitted from the volatile memory to the at least one of the plurality of ready to be flashed mobile devices (880) in the concurrent flashing session.

In some instances, the term concurrent does not require simultaneous transmission, but does require that the mobile devices are simultaneously tethered to the workbench. In such a session, the individual segment(s) can be transmitted in an ordered sequence that may include simultaneous and/or continuous transmissions. The transmissions can also be sequential, incremental and/or periodic transmissions. In some embodiments, the one or more common packets are transmitted separately (in time and/or channel) from the one or more unique packets. In an alternate embodiment, the one or more common packets are simultaneously transmitted to each of the plurality of ready to be flashed mobile devices.

Different configurations can also be used for storing the packages. For instance, the one or more unique packets can be stored in the volatile memory of the workbench computing system separately from the common packets. In some instances, only a single copy of the one or more common packets remains within the volatile memory at any given time during the flashing session.

As described above, the disclosed embodiments for implementing de-duplication during flashing can be utilized to obtain significant savings in the processing and storage requirements that are otherwise necessary for flashing a plurality of devices that are concurrently flashed during a single flashing session. Other advantages and technical benefits of the present disclosure are also evident from the foregoing description.

With regard to the foregoing disclosure and recited methods, it will be appreciated that the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A workbench computing system that implements a method of flashing a plurality of ready to be flashed mobile devices from the workbench computing system, the workbench computing system comprising:
one or more processors;
volatile memory configured for at least temporarily storing packets to be flashed to a plurality of ready to be flashed mobile devices;
one or more storage device having stored computer-executable instructions which are executable by the one or more processors for causing the workbench computing system to perform the following:
the workbench computing system identifying the plurality of ready to be flashed mobile devices, the plurality of ready to be flashed mobile devices being tethered to the workbench computing system during a flashing session, and wherein the plurality of ready to be flashed mobile devices are untethered from the workbench computing system upon completion of the flashing session;
the workbench computing system accessing one or more common payload packets to be flashed to each of the plurality of ready to be flashed mobile devices from volatile memory of the workbench computing system during the flashing session as well as one or more uncommon packets that are to be selectively flashed to only a subset of the plurality of ready to be flashed mobile devices during the flashing session; and
the workbench computing system transmitting the one or more common payload packets to the plurality of ready to be flashed mobile devices concurrently during the flashing session while refraining from making and simultaneously storing a separate copy of the one or more common payload packets in the volatile storage for each of the plurality of ready to be flashed mobile devices during the flashing session.

2. The workbench computing system of claim 1, wherein the computer-executable instructions are further executable by the one or more processors for causing the workbench computing system to perform the following:
the workbench computing system transmitting the one or more common payload packets to the plurality of ready to be flashed mobile devices during the flashing session while refraining from creating and storing a separate FFU (Flash File Uploader) file that includes the one or more common payload packets for each of the plurality of ready to be flashed mobile devices at the volatile storage of the workbench computing system.

3. The workbench computing system of claim 1, wherein the computer-executable instructions are further executable by the one or more processors for causing the workbench computing system to perform the following:
the workbench computing system signing the one or more common payload packets separately from the one or more uncommon packets with the OEM (Original Equipment Manufacturer) digital certificate.

4. A method for flashing a blank mobile device from a workbench computing system, the method comprising:
identifying a plurality of ready to be flashed mobile devices to be flashed, the plurality of ready to be flashed mobile devices being concurrently tethered to the workbench computing system;
identifying an initial flashing payload to be flashed to the plurality of ready to be flashed mobile devices during a flashing session, wherein the blank mobile devices are concurrently tethered to the workbench computing system during the flashing session and wherein the plurality of ready to be flashed mobile devices are untethered from the workbench computing system upon completion of the flashing session;
identifying one or more unique packets that are to be transmitted to at least one of the plurality of ready to be flashed mobile devices as part of the flashing payload and that will not be transmitted to at least another one of the plurality of ready to be flashed mobile devices during the flashing session;
identifying one or more common packets from the initial flashing payload that will be transmitted to each of the plurality of ready to be flashed mobile devices concurrently during the flashing session;
writing the one or more common packets in volatile memory of the workbench computing system, without creating and storing a separate copy of the one or more common packets in the volatile memory of the workbench simultaneously for each of the plurality of ready to be flashed mobile devices;
writing the one or more unique packets in the volatile memory of the workbench computing system;
transmitting the one or more common packets to each of the plurality of ready to be flashed mobile devices during the flashing session; and
transmitting the one or more unique packets from the volatile memory to the at least one of the plurality of ready to be flashed mobile devices.

5. The method of claim 4, wherein the method further includes transmitting the one or more common packets separately from the one or more unique packets.

6. The method of claim 4, wherein the method further includes storing the one or more unique packets in the volatile memory of the workbench computing system separately from the common packets

7. The method of claim 4, wherein the method further includes transmitting the one or more common packets simultaneously to each of the plurality of ready to be flashed mobile devices.

8. The method of claim 4, wherein the method further includes segmenting the one or more common packets and transmitting the one or more common packets incrementally within a plurality of incremental transmissions to each of the plurality of ready to be flashed mobile devices.

9. The method of claim 4, wherein writing the one or more common packets in volatile memory of the workbench computing system is performed in such a way that only a single copy of the one or more common packets remains within the volatile memory at any given time during the flashing session.

10. The method of claim 4, wherein the one or more common packets comprise an OS (operating system) for the blank mobile device.

11. The method of claim 4, wherein the identifying the one or more common packets and the one or more unique packets is based on information obtained at the workbench computing system prior to tethering of the plurality of ready to be flashed mobile devices to the workbench computing system.

12. The method of claim 4, wherein the identifying the one or more common packets and the one or more unique packets is based on information obtained from the plurality of blank mobile devices upon tethering the plurality of ready to be flashed mobile devices to the workbench computing system and which was installed on the plurality of ready to be flashed mobile devices prior to the flashing session and prior to an operating system having been installed on the plurality of ready to be flashed mobile devices.

13. The method of claim 4, wherein the at least one of the plurality of ready to be flashed mobile devices and the at least another one of the plurality of ready to be flashed mobile devices are manufactured from a same OEM (original equipment manufacturer), and such that the one or more unique packets is selectively flashed to the at least one of the plurality of blank mobile device without being flashed to all of the plurality of ready to be flashed mobile devices manufactured from the same OEM during the flashing session.

14. The method of claim 4, wherein the method includes examining a packet manifest and determining which one or more packet from the packet manifest is absent from the at least one of the plurality of ready to be flashed mobile devices in an operable state.

15. The method of claim 4, wherein the identifying one or more unique packets that are to be transmitted is performed subsequent to transmitting the one or more common packets.

16. The method of claim 4, wherein the one or more unique packets are transmitted to at least two of the plurality of ready to be flashed mobile devices.

17. The method of claim 4, wherein the method further includes simultaneously transmitting the one or more unique packets and the one or more common packets during the flashing session to one or more of the plurality of ready to be flashed mobile devices.

18. The method of claim 4, wherein the method further includes signing the one or more common payload packets separately from the one or more unique packets with the OEM (Original Equipment Manufacturer) digital certificate.

19. A method for flashing a plurality of ready to be flashed mobile devices from a workbench computing system, the method comprising:
identifying the plurality of ready to be flashed mobile devices, the plurality of ready to be flashed mobile devices being tethered to the workbench computing system during a flashing session, and wherein the plurality of ready to be flashed mobile devices are untethered from the workbench computing system upon completion of the flashing session;
identifying one or more common payload packets to be flashed to each of the plurality of ready to be flashed mobile devices from volatile memory of the workbench computing system during the flashing session as well as one or more uncommon packets that are to be selectively flashed to only a subset of the plurality of ready to be flashed mobile devices during the flashing session; and
transmitting the one or more common payload packets to the plurality of ready to be flashed mobile devices concurrently during the flashing session while refraining from making and simultaneously storing a separate copy of the one or more common payload packets in the volatile storage for each of the plurality of ready to be flashed mobile devices during the flashing session.

20. The method of claim 19, wherein the method further includes transmitting the one or more common payload packets to the plurality of ready to be flashed mobile devices during the flashing session while refraining from creating and storing a separate FFU (Flash File Uploader) file that includes the one or more common payload packets for each of the plurality of ready to be flashed mobile devices at the volatile storage of the workbench computing system.
